(19) United States
(12) Patent Application Publication
(10) Pub. No.: US 2008/0052893 A1
(43) Pub. Date: Mar. 6, 2008

(54) BENDING OF INSULATED PIPE

(76) Inventor: Alan Everett Vriend, Edmonton (CA)

Correspondence Address: ADE & COMPANY INC., 2157 Henderson Highway, WINNIPEG, MB, R2G1P9, US

(21) Appl. No.: 11/843,704

(22) Filed: Aug. 23, 2007

Related U.S. Application Data
(60) Provisional application No. 60/839,713, filed on Aug. 24, 2006.

(51) Int. Cl. B23P 11/00

(52) U.S. Cl. 29/505

(57) ABSTRACT

A method is provided for bending insulated metal pipe having an inner tubular pipe of the order of 0.5 to 1.00 inches diameter surrounded by a layer of a foam or other insulation material of the order of 1.5 to 2.0 inches diameter. The insulated pipe is manually grasped and pulled into a curve around a part circular channel shaped to receive and cup the outside surface of the insulated metal pipe where the channel has a diameter greater than 1.5 inches and the bender is formed solely from the channel member so as to be free from a handle or foot pedal portion to assist with bending. The channel includes at one end a portion which wraps around the insulated pipe to hold the pipe at that portion within the channel.

This application claims the benefit under 35 U.S.C. 119 from Provisional application 60/839,713 filed Aug. 24, 2006.

This invention relates to a method for use in bending pre-insulated pipe.

### BACKGROUND OF THE INVENTION

Plumbing using insulated pipe is a common practice. Bending of pipes is a common requirement so that a pipe can follow a required path. However the insulated pipe which is a metal tubular pipe surrounded by a foam or wrapped fabric exterior insulation material surrounded by an impervious flexible sheathing is relatively delicate and requires careful handling to provide the necessary bending action without damaging the insulation at locations along the insulation since this of course will allow heat transfer at the point where insulation is damaged. At the present time tools dedicated for this particular purpose are not available and significant difficulty is encountered with handling this type of material by providing necessary bends. Typically insulated pipe of this type has an outer diameter of the insulation material of the order of 1.5 to 2.0 inches and includes a stainless steel pipe core of the order of 0.5 to 1.00 inches.

The bending of conventional steel or copper pipes can be carried out using a device of the type shown n U.S. Pat. Nos. 2,584,537 issued February 5^{th} 10952 and 3,063,414 issued November 13^{th} 1962 both to Benfield. This device includes an arcuate channel member which has a loop at one end to grasp the pipe. However this device includes a handle extending at right angles from the channel member and a foot pedal onto which pressure can be applied from the foot of the user. These aids to effecting the bending action and its overall design and general construction effectively limit this device to the bending of solid piping. Furthermore its action is such as to prevent its use “in situ”, rather constraining its user to perform its actions against and/or on a solid surface on defined lengths of piping.

Despite the availability of this pipe bender on the market place for many years, nothing has been made available or suitable for insulated pipe of the type described above.

### SUMMARY OF THE INVENTION

It is one object of the invention to provide a method for bending insulated metal pipe. The design of the invention is such as to allow its use on unlimited piping lengths, “in situ” and in constrained situations.

According to the invention there is provided a method for bending insulated metal pipe having an inner tubular pipe surrounded by a layer of an insulation material, the method comprising:

providing an integral elongate body;

the body being shaped in cross-section to define a part circular channel shaped to receive and cup an outside surface of the insulated metal pipe;

the channel typically having a diameter greater than 1.5 inches;

the body being curved along its length so as to define a part circular shape lying in a plane and curved around an axis a right angles to the plane;

the body being formed solely from the channel member so as to be free from a handle or foot pedal portion to assist with bending;

the body extending in the plane around an angle greater than 90 degrees;

the body being curved with the channel open outwardly of the curve;

the body including at one end a portion which wraps around the insulated pipe to hold the pipe at that portion within the channel;

inserting an end of the insulated metal pipe into the portion such that the portion wraps around the end to hold the end in the channel;

and manually grasping and bending the insulted metal pipe into the channel from the end at the portion around to an opposite end of the channel so as to manually seat the outer periphery of the insulated pipe within the channel;

and removing the pipe from the channel and the portion when bent.

Preferably the portion wraps only partly around the pipe leaving one part of the pipe open.

Preferably the portion wraps around to a position opposite a center line of the channel so that the open portion is to one side of a plane containing the center line.

Preferably the portion is attached to the channel at one side of the channel.

Preferably the portion forms an extension of one side wall of the channel and preferably the other side wall is recessed at a top edge at the portion.

Preferably extends to an end beyond the end of the channel so as to form a generally cork-screw shape from one side wall around toward the opposite side wall of the channel.

Preferably the part circular channel shape is substantially semi-circular. However it may be slightly more or slightly less than 190 degrees provided it cups and retains the pipe as it is bent around the curvature of the body.

Preferably the body is curved around an angle less than 180 degrees.

Preferably the apparatus consists solely of the channel and the portion so that the tool is simple and light weight and one piece.

### BRIEF DESCRIPTION OF THE DRAWINGS

One embodiment of the invention will now be described in conjunction with the accompanying drawings in which:

FIG. 1 is an end elevational view of the bending tool according to the present invention containing an end of a portion of insulated pipe to be bent.

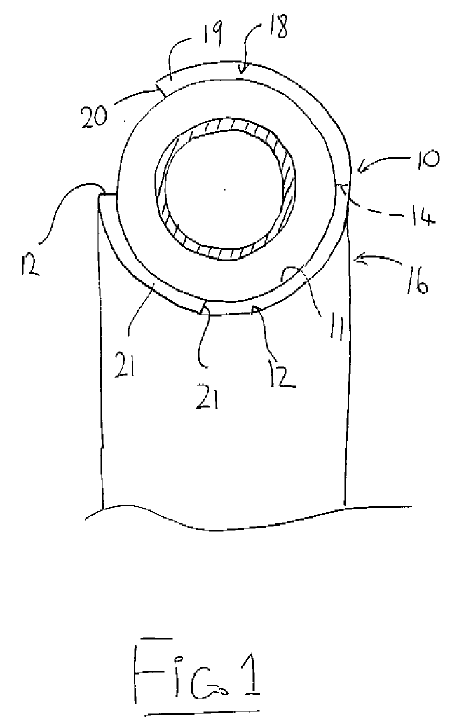

FIG. 2 is an isometric view of the tool of FIG. 1.

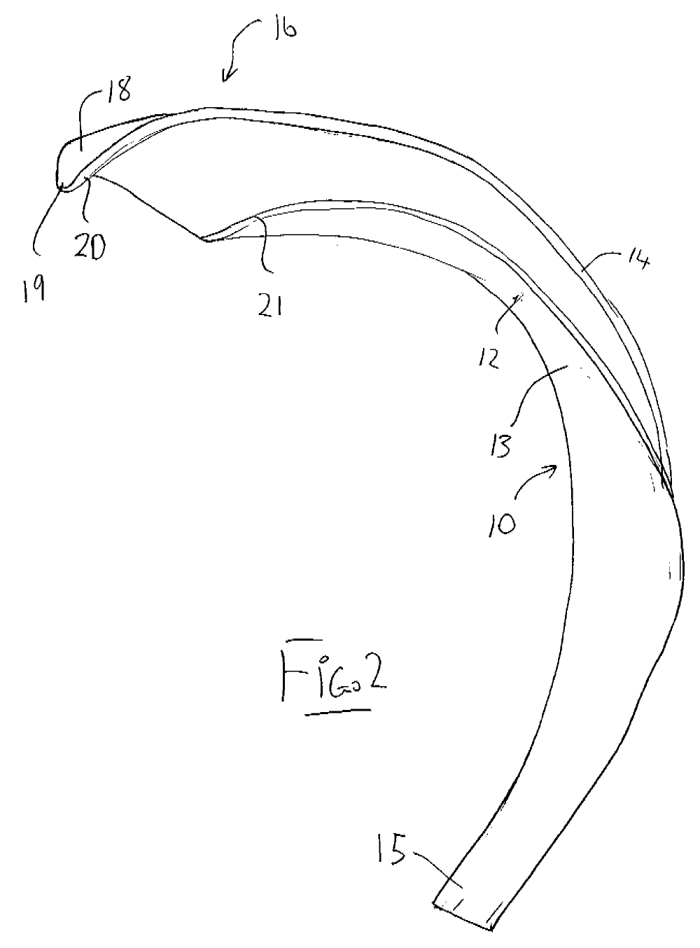

FIG. 3 is side elevational view of the tool and pipe of FIG. 1.

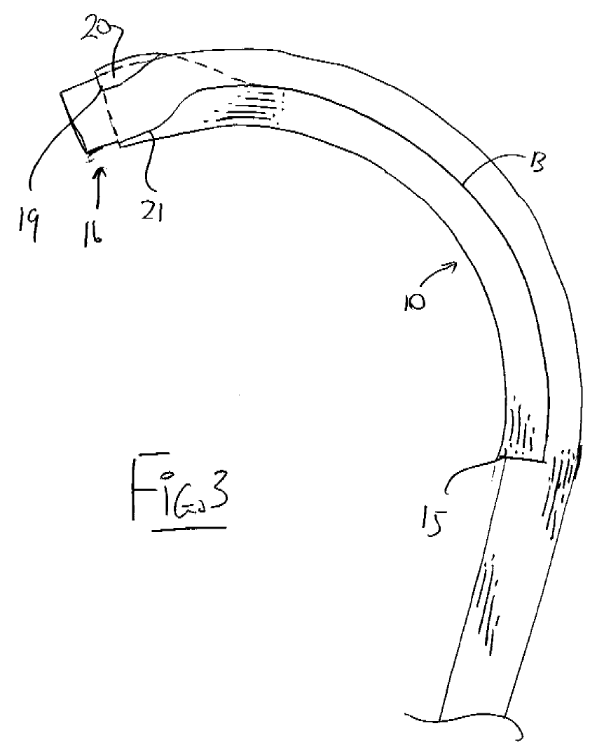

In the drawings like characters of reference indicate corresponding parts in the different figures.

### DETAILED DESCRIPTION

The bending device comprises an integral body 10. The integral body 10 is firstly shaped to form a channel having an inner surface and an outer surface 12 with a channel being of semi-circular cross sectional shape so as to form edges 12 and 13 of the channel. The wall of the channel is of substantially constant thickness so that the outside is semi circular and the inside surface is also semi circular. The body extends from a first end 15 to a second end 16. The body is curved so as to lie in a common plane with the center line of the channel lying in that plane and with the channel facing outwardly of the curvature. The curvature is generally circular around an axis at right angles from the plane to form a radius of curvature of the order of six inches. The body curves from the end 15 to the end 16 around an angle around the axis of the order of 135° which is greater than 90° and less than the 180° of a half turn.

At the end 15 the body simply terminates in an end which is at right angles to the axis of the channel. At the opposite end 16, one side wall 11 of the channel is increased in height so as to form an extension portion 17. This extension portion is then curved around the axis of the channel so as to form a portion 18 which is opposite to the channel. This portion 18 extends beyond the base of the channel to an end 19. The portion 18 follows the curvature of the channel so as to lie generally on a cylinder coaxial with the channel. The portion 18 has an edge 20 which increases in extension from the top edge 14 around to the end 19. In this way in effect a corkscrew arrangement is provided where the edge 20 spirals around the axis of the channel. At the same time the edge 13 includes a portion 21 which reduces in height so that the side wall of the channel recesses around the axis of the channel as the side edge 20 increases in distance around the axis of the channel. However these two portions as best shown in the end view provide an arrangement which surrounds a part of the insulated pipe so as to enclose that part of the pipe.

In operation an end of the pipe is inserted onto the end part of the channel and pushed into the corkscrew end portion 17 so that the end is trapped on top of the channel and underneath the portion 18. This holds the portion in place of the pipe since the outside diameter of the pipe substantially matches the inside diameter of the portion 18 and the channel. As this end part of the pipe is held in place, the user can work the part of the pipe extending from that end around into the channel following the curvature of the body until sufficient of the pipe is inserted into the channel to provide a bend of the angle required.

The curvature of the tool extends around at an angle of greater than 90° since there is a tendency of the material to spring back when released from the bending tool. The angle of 135° therefore will generate a curvature of the order of 90°. If a second curvature is required to a 180° the tool can be used by moving the end of the tool along the pipe to the beginning of the portion that requires further bending and a further bending action can be effected.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for bending insulated metal pipe having an inner tubular pipe surrounded by a layer of a foam or other insulation material, the method comprising:
providing an integral elongate body;
the body being shaped in cross-section to define a part circular channel shaped to receive and cup an outside surface of the insulated metal pipe;
the channel typically having a diameter greater than 1.5 inches;
the body being curved along its length so as to define a part circular shape lying in a plane and curved around an axis a right angles to the plane;
the body being formed solely from the channel member so as to be free from a handle or foot pedal portion to assist with bending;
the body extending in the plane around an angle greater than 90 degrees;
the body being curved with the channel open outwardly of the curve;
the body including at one end a portion which wraps around the insulated pipe to hold the pipe at that portion within the channel;
inserting an end of the insulated metal pipe into the portion such that the portion wraps around the end to hold the end in the channel;
and manually grasping and bending the insulted metal pipe into the channel from the end at the portion around to an opposite end of the channel so as to manually seat the outer periphery of the insulated pipe within the channel;
and removing the pipe from the channel and the portion when bent.

2. The method according to claim 1 wherein the portion wraps only partly around the insulated pipe leaving one part of the pipe open.

3. The method according to claim 1 wherein the portion wraps around to a position opposite a center line of the channel.

4. The method according to claim 1 wherein the portion is attached to the channel at one side of the channel.

5. The method according to claim 1 wherein the portion forms an extension of one side wall of the channel.

6. The method according to claim 5 wherein the other side wall is recessed at a top edge at the portion.

7. The method according to claim 1 wherein the portion extends to an end beyond the end of the channel.

8. The method according to claim 1 wherein the part circular channel shape is substantially semi-circular.

9. The method according to claim 1 wherein the body is curved around an angle less than 180 degrees.
